(19) United States
(12) Patent Application Publication
(10) Pub. No.: US 2024/0233171 A1
(43) Pub. Date: Jul. 11, 2024

(54) SYSTEM FOR IMAGE-BASED IDENTIFICATION OF THE POSITION OF A CARGO CONTAINER

(71) Applicant: Deere & Company, Moline, IL (US)

(72) Inventors: Patrick Sauer, Rheinland Palatinate (DE); Akshay Khot, Rheinland Palatinate (DE)

(21) Appl. No.: 18/522,733

(22) Filed: Nov. 29, 2023

(30) Foreign Application Priority Data
Jan. 11, 2023 (DE) 102023100540.5

(51) Int. Cl. G06T 7/73; G06T 7/12; G06T 7/593

(52) U.S. Cl. CPC G06T 7/73; G06T 7/12; G06T 7/593; G06T 2207/10012; G06T 2207/20081; G06T 2207/30252

(57) ABSTRACT

A system for image-based identification of the position of a cargo container, a vehicle equipped therewith, and a corresponding method. The cargo container comprises edges and corners. The system comprises an electro-optical unit, which is or can be directed on the cargo container and is configured to provide an image signal which contains distance information, and an electronic evaluation unit, which is connected in a signal-transmitting manner to the electro-optical unit and is configured to generate, on the basis of the image signal, a distance image with respect to the spatial location of the edges of the cargo container and a two-dimensional estimation of the position of the corners of the cargo container within the image and to provide a position signal with respect to the spatial position of the corners of the cargo container on the basis of the distance image and the estimation.

### FIELD OF THE DISCLOSURE

The disclosure relates to a system for image-based identification of the position of a cargo container, a vehicle equipped therewith, and a corresponding method.

### BACKGROUND OF THE DISCLOSURE

When harvesting agricultural products on a field using a harvesting machine, it is routine practice that a transport vehicle travels along adjacent to the harvesting machine and is loaded with harvested plant material. A cargo container of the transport vehicle, which is for example a tractor having a trailer or truck, is loaded during the journey by a discharge unit of the harvesting machine with the harvested product, for example, in a forage harvester by a discharge spout and in a combine harvester by a discharge pipe. The discharge unit is generally fastened rotatably around a vertical axis on the harvesting machine and is pivotable between a shutdown position, in which it is oriented approximately parallel to the longitudinal axis of the harvesting machine, and a working position, in which it extends transversely to the travel direction of the harvesting machine.

With discharge units adjustable in operation, as are typically used on forage harvesters, there is the possibility of varying the angle of the discharge unit around the vertical axis. In addition, the height of the delivery-side end of the discharge unit is variable, as is the position of a discharge flap, which defines the angle at which the harvested product is delivered. The position of the discharge unit is manually controlled by the driver of the harvesting machine in the simplest case, for which purpose input units in the cab are available to him, which activate actuators used for adjusting the discharge unit. The driver of the harvesting machine has to take care in this case that the entire cargo container of the transport vehicle is sufficiently filled, which is carried out by successively orienting the discharge unit toward different points on the cargo container. Alternatively, or additionally, the driver of the transport vehicle changes its position in relation to the harvesting machine in the forward direction and possibly in the lateral direction in order to fill different areas of the cargo container in succession. This procedure is also typical in combine harvesters, which generally have no discharge unit or a discharge unit adjustable in operation only around the vertical axis (see EP 2 893 797 A2).

A number of proposals have been made to automate the transfer process, whether by automatic controlling of the orientation of the transfer unit in relation to the harvesting machine and thus the throwing direction of the delivered harvested material and/or by controlling the position of the cargo container of the transport vehicle in relation to the harvesting machine. It is therefore detected by means of a sensor and/or calculated by means of a model at which point the harvested material lands on the cargo container and the orientation of the transfer unit and/or relative position of the cargo container is controlled (regulated or controlled) accordingly. A specific loading strategy can be worked out for this purpose in order to fill different points of the cargo container gradually. Similar transfer processes, which are partially also already automated, also take place in agricultural machines which discharge material onto a field and are to be refilled from time to time (for example, fertilizer spreaders or sowing machines), or in machines which pick up arbitrary material from the ground that is to be transported away, for example, soil or road material.

In the automatic transfer of arbitrary materials, it is important that usable information with respect to the location of the edges of the cargo container is provided to a control unit, in order to be able to control the transfer automatically. In previous designs, a receiver attached to the cargo container or to a vehicle pulling it is used for this purpose to receive signals of a satellite-based position system (GNSS (global navigation satellite system), such as GPS, Galileo, etc.), cf., for example, DE 100 64 860 A1, the signals of which are transmitted to the vehicle to be loaded, so that the relative position can be ascertained there on the basis of a further receiver. In order to avoid the expenditure linked thereto, furthermore image-based systems have been proposed, which detects the cargo container by means of an electro-optical device, which can be embodied, for example, as a monocular or stereo camera having an image processing system or as an active, distance-measuring system (laser scanner, PMD camera).

The position of the cargo container is typically detected on the basis of its edges, which are identified in the image provided by the camera by a suitable algorithm and are capable in case of the use of a stereo camera of outputting the location of the corners in three-dimensional coordinates, for which purpose, reference is made, for example, to DE 10 2007 009 666 A1, EP 2 301 318 A1, WO 2013/120062 A1 and Zhang, W.et al., Autonomous Identification and Positioning of Trucks during Collaborative Forage Harvesting, Sensors 2021, 21, 1166. Liu, D.et al., Grain Truck Loading Status Detection Based on Machine Vision, Proceedings of the 2019 IEEE 4th International Conference on Image, Vision and Computing (ICIVC), Xiamen, China, 5-7 Jul. 2019; pages 40-44, describe edge detection of the container on the basis of a cellular neural network (CNN), which is trained by means of an algorithm that simulates the behavior of an ant lion. Moreover, the fill level of the container is calculated.

Systems based on machine learning are also used to identify the type of a cargo container, see EP 3 903 558 A1, WO 2022/130038 A1, WO 2022/1300039 A1, or to create a model for the flight behavior of the harvested material during the transfer (EP 3 316 218 A1, EP 3 949714 A1).

In the previous stereo camera-based systems for identifying the edges and therefore corners of the cargo container, it has proven to be problematic to develop an algorithm which manages under the sometimes problematic conditions occurring in practice, having different shapes, colors, and lighting situations.

The object underlying the disclosure is considered that of providing a system for image-based identification of a cargo container, which is distinguished by robustness, accuracy, and universal usability and which does not have the mentioned disadvantages or only has them to a reduced extent.

### SUMMARY OF THE DISCLOSURE

A system and a method for image-based identification of the position of a cargo container comprise the following features or corresponding steps: an electro-optical unit that is or can be directed on the cargo container and is configured to provide an image signal that contains distance information, and an electronic evaluation unit which is connected in a signal-transmitting manner to the electro-optical unit and is configured to generate, on the basis of the image signal, a distance image with respect to the three-dimensional location of the edges of the cargo container and a two-dimensional estimation of the position of the corners of the cargo container within the image and to provide a position signal with respect to the three-dimensional position of the corners of the cargo container on the basis of the distance image and the estimation.

In other words, two types of features are extracted from the image signal, namely a three-dimensional distance image that represents the location of the edges of the cargo container and a two-dimensional estimation of the position of the corners of the cargo container. Finally, the three-dimensional position of the corners is determined on the basis of the two. Accordingly, two different analysis methods are applied to the image signal, which identify different features. The robustness of the image processing is thus improved and the susceptibility to error is reduced.

The electronic evaluation unit can comprise a system configured for generating the distance image and/or the estimation, which is trained on the basis of training images and associated information with respect to the location of the cargo container. The system is configured in particular to learn solutions to multiple tasks simultaneously. A system configured for machine learning is therefore used, for example, a suitable neural network, which is trained in a first step and uses its learned knowledge in practical use. The training takes place on the basis of a sufficiently high number of typical images, which occur in practice, of cargo containers that are presented to the system. At the same time, the associated output values (for the three-dimensional distance image, which represents the location of the edges of the cargo container, and additionally or alternatively thereto the associated two-dimensional estimation of the position of the corners of the cargo container) are supplied to the system. In the first step, the system learns the relationships between image signals and associated output values, and in the second step, it applies these relationships to the image signals received in practical use in order to generate the output values. In embodiments in which only the distance image or the estimation is generated by a machine-learning system, a classic system known per se can be used for the respective other output value (estimation or distance image), which generates the result on the basis of algorithms known per se.

The system can be configured to carry out a semantic segmentation to identify a cargo container and to identify the corners of the cargo container in the part of the image identified as the cargo container. In the segmentation, the image signal is divided and assigned to different objects, e.g., ground, cargo container, other vehicles, trees, etc. The parts of the image assigned to the cargo container enable an identification of its corners. This procedure takes place in two-dimensional space in order to keep the required computing capacity within limits.

The electro-optical unit can in particular be a stereo camera and the three-dimensional distance image which represents the location of the edges of the cargo container can be a disparity image.

The evaluation unit can be configured to use the position signal to generate a control signal for an actuator for the automatic supervision of a transfer process of material into the cargo container or to supply it to a control unit carrying out this task.

A vehicle, in particular a harvesting machine or a machine for filling an agricultural machine with consumable material, such as fertilizer or seeds, can be equipped with means for picking up and/or storing and for transferring material into the cargo container and with a described system. It would also be conceivable to provide the present system on a (road) construction machine, which picks up road material and transfers it to a cargo container for removal, for example.

Other features and aspects will become apparent by consideration of the detailed description and accompanying drawings.

### BRIEF DESCRIPTION OF THE DRAWINGS

FIG. 1 is a side view of a self-propelled harvesting machine and a transport vehicle having a cargo container, according to one embodiment;

FIG. 2 is a schematic top view of the harvesting machine and the transport vehicle of FIG. 1, which carry out a harvesting and transfer process jointly on a field, wherein the harvested material is transferred to the cargo container of the transport vehicle;

FIG. 3 is a rear view of the harvesting machine and the transport vehicle from FIG. 2;

FIG. 4 is a schematic illustration of the control unit for controlling the transfer of the harvested material;

FIG. 5 is a diagram of the design and the functionality of the processing circuit used for the image-based identification of the position of the cargo container; and

FIG. 6 is a diagram corresponding to FIG. 5 with exemplary images of the cargo container during the processing.

Before any embodiments are explained in detail, it is to be understood that the disclosure is not limited in its application to the details of construction and the system of components set forth in the following description or illustrated in the following drawings. The disclosure is capable of other embodiments and of being practiced or of being carried out in various ways. Further embodiments of the disclosure may include any combination of features from one or more dependent claims, and such features may be incorporated, collectively or separately, into any independent claim.

### DETAILED DESCRIPTION

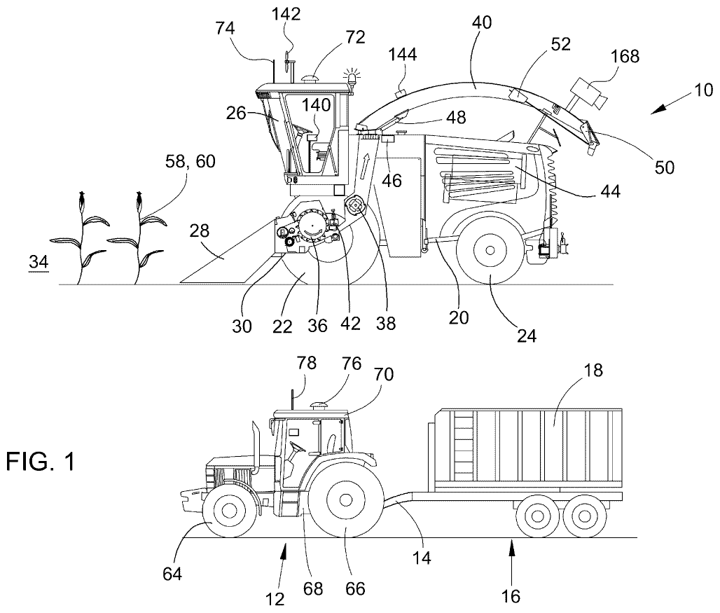

A combination of two agricultural machines shown in FIG. 1 comprises a harvesting machine 10 in the form of a self-propelled forage harvester and a transport vehicle 12 in the form of a self-propelled tractor, which pulls a trailer 16, which comprises a cargo container 18, by means of a drawbar 14.

The harvesting machine 10 is built on a frame 20, which is supported by front driven wheels 22 and steerable rear wheels 24. The harvesting machine 10 is operated from a driver cab 26, from which a harvesting header 28 in the form of a corn cutting header is visible, and is fastened at an intake channel 30 on the front side of the harvesting machine 10. By means of the harvesting header 28, harvested material picked up from a field 34 is supplied, via an intake conveyor having feed rollers and arranged in the intake channel 30, to a cutterhead 36, which chops it into small pieces and delivers it to a fan 38. A secondary crushing device 42 having two grain processor rollers extends between the cutterhead 36 and the fan 38. The mentioned drivable assemblies of the harvesting machine 10 and the harvesting header 28 are driven by means of an internal combustion engine 44.

The material discharged from the fan 38 leaves the harvesting machine 10 and goes to the cargo container 18 driving alongside via a discharge unit, which is composed of a stationary discharge shaft adjoining the fan 38 directly on top and a discharge spout 40, which is rotatable by means of a first, power-operated actuator 46 around an approximately vertical axis and is adjustable in the inclination by means of a second, power-operated actuator 48, the discharge direction of which is changeable by a discharge flap 50, the inclination of which is adjustable by means of a third, power-operated actuator 52. The discharge spout 40 and the discharge flap 50 are shown in their transport position in FIG. 1, into which they are brought, for example, when the harvesting machine 10 drives on a road. During the harvesting process, the discharge spout 40 is raised by means of the actuator 48 and, by means of the actuator 46, either rotated to a side of the harvesting machine 10 if sufficient space is present after the harvesting laterally to the harvesting machine 10 for the transport vehicle 12 on a harvested area 56 of the field, or the discharge spout 40 remains in the position oriented to the rear according to FIG. 1 if initially a lane is cut into the field, but is raised by the actuator 48.

The transport vehicle 12 and the trailer 16 are of conventional design. The transport vehicle 12 comprises front steerable wheels 64 and rear driven wheels 66, which are supported on a frame 68, which carries a driver cab 70.

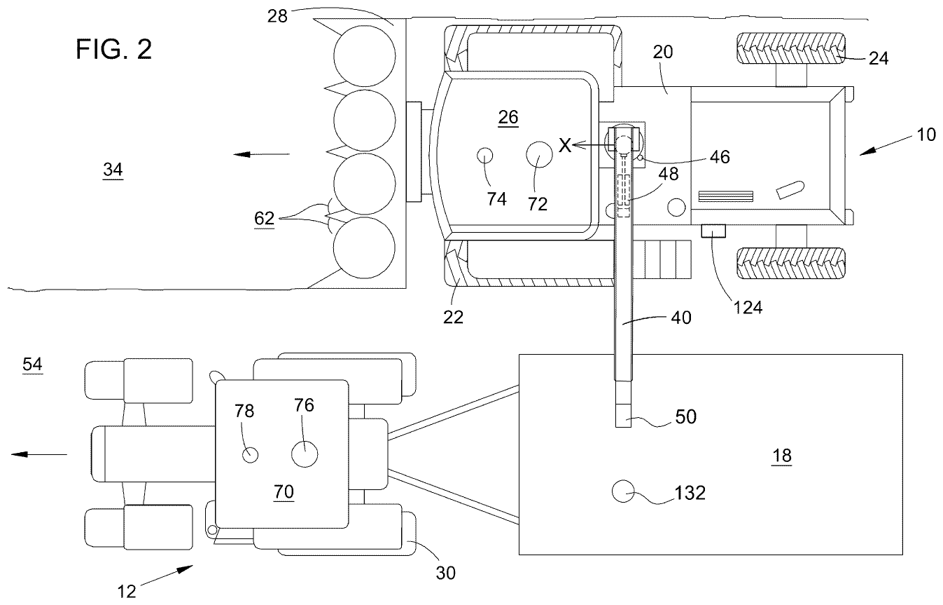

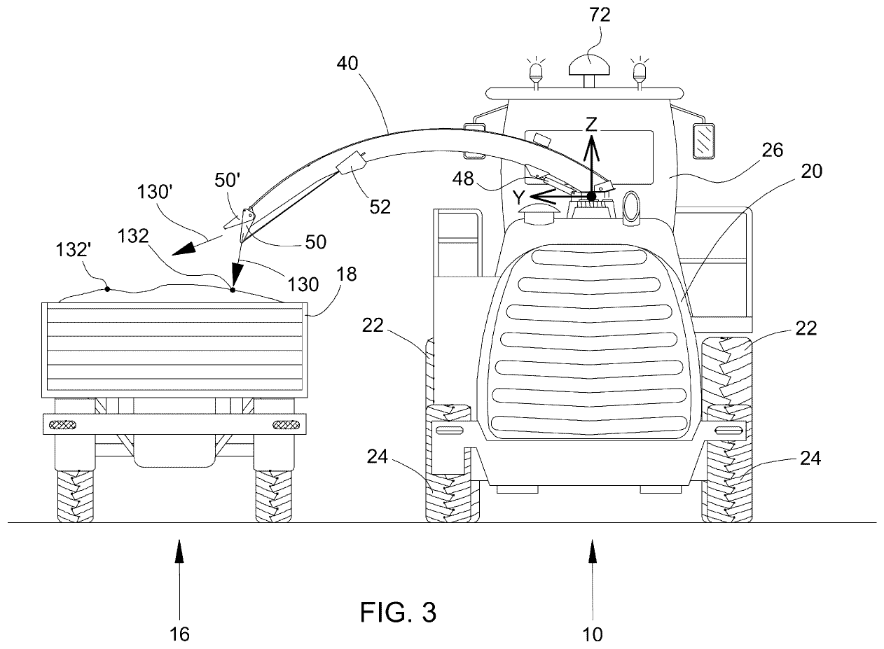

The harvesting machine 10 and the transport vehicle 12 are shown in a top view in FIG. 2. It is apparent that the harvesting machine 10 travels along a harvested material edge, representing a boundary between the harvested area 54 of the field 34 and the still standing stock 60 of the field 34 occupied with corn plants 58, and harvests the plants 58. The transport vehicle 12 travels on the harvested area 54 of the field 34 parallel to the harvesting machine 10 along a path on which the plants cut by the harvesting machine 10 reach the first cargo container 18 through the discharge unit. The transport vehicle 12 typically travels parallel adjacent to the harvesting machine 10, as shown in FIG. 2. During the harvesting, however, the transport vehicle 12 can also travel behind the harvesting machine 10, since a harvested part 54 of the field 34 on which the transport vehicle 12 could travel without damaging the plants standing there is not yet present. A rear view of the situation shown in FIG. 2 is shown in FIG. 3.

The harvesting machine 10 is steered by a driver seated in the driver cab 18 or by an automatically working steering device, which is known per se, in particular on the basis of sensing bands 62 for detecting the harvested material rows. The transport vehicle 12 is also equipped with a steering unit, described in more detail hereinafter, to facilitate or automate the parallel driving in relation to the harvesting machine 10. The harvesting machine 10 could also be any other self-propelled harvesting machine, such as a combine harvester or beet harvester, in which the transfer unit is generally not adjustable in operation.

The harvesting machine 10 is equipped with a first position determination unit 72 for receiving signals of a satellite-based navigation system (GNSS), which is located on the roof of the cab 26. A first radio antenna 74 is also positioned there.

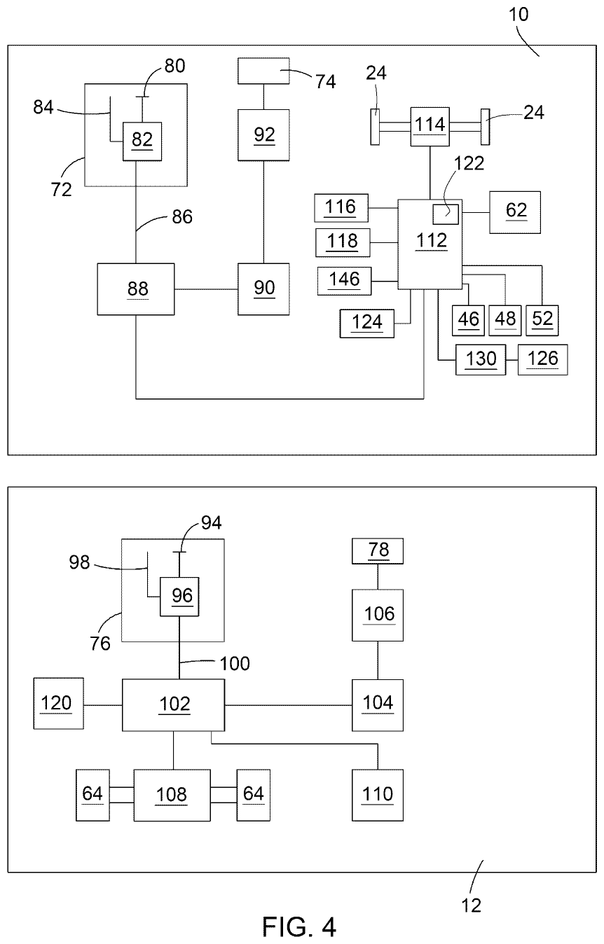

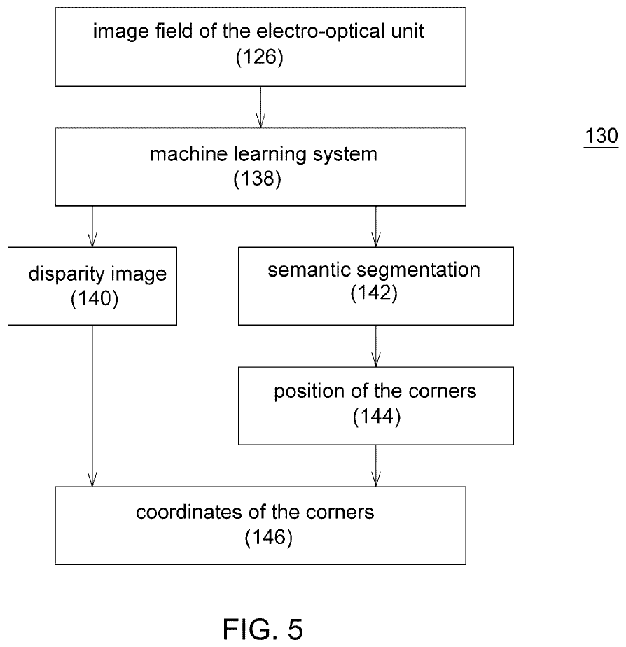

The transport vehicle 12 is equipped with a second position determination unit 76, which is located on the roof of the cab 70. A second radio antenna 78 is also positioned there. In addition, the harvesting machine 10 is equipped with an electro-optical unit 126, which is attached at the outer end of the discharge spout 40 and is used to detect the contours of the cargo container 18 and, where appropriate, its fill level with harvested material. The electro-optical unit 126 can be an ultrasonic or radar or laser distance meter two-dimensionally scanning its field of view directed toward the cargo container 18, or it is a three-dimensionally operating (PMD) camera, or two cameras, which generate a stereo image, or a two-dimensionally operating camera which is combined with a distance meter scanning the field of view. The output signal of the electro-optical unit 126 is processed by a processing circuit 130 (cf. FIGS. 4 and 5), which is used as the system for image-based identification of the position of a cargo container 18 according to the present disclosure.

Reference will now be made to FIG. 4, in which the individual components of the system for controlling the transfer of the harvested material from the harvesting machine 10 to the cargo container 18, including the electro-optical unit 126 and the position determination units 72, 76, and the steering unit of the transport vehicle 12 and the harvesting machine 10 are schematically shown. The first position determination unit 72, which comprises an antenna 80 and an evaluation circuit 82 connected to the antenna 80, is located on board the harvesting machine 10. The antenna 80 receives signals from satellites of a position determination system, such as GPS, Galileo, or Glonass, which are supplied to the evaluation circuit 82. The evaluation circuit 82 determines the current position of the antenna 80 on the basis of the signals of the satellites. The evaluation circuit 82 is furthermore connected to a correction data receiving antenna 84, which receives radio waves emitted by reference stations at known locations. Correction data for improving the accuracy of the position determination unit 72 are generated on the basis of the radio waves by the evaluation circuit 82.

The evaluation circuit 82 transmits its position data to a computer unit 88 through a bus line 86. The computer unit 88 is connected via an interface 90 to a receiving and transmitting unit 92, which is in turn connected to the radio antenna 74. The receiving and transmitting unit 92 receives and generates radio waves, which are received or emitted by the antenna 74.

Similarly, a second position determination unit 76, which comprises an antenna 94 and an evaluation circuit 96 connected to the antenna 94, is located on board the transport vehicle 12. The antenna 94 receives signals from satellites of the same position determination system as the antenna 80, which are supplied to the evaluation circuit 96. The evaluation circuit 96 determines the current position of the antenna 94 on the basis of the signals of the satellites. The evaluation circuit 96 is furthermore connected to a correction data receiving antenna 98, which receives radio waves emitted by reference stations at known locations. Correction data for improving the accuracy of the position determination unit 76 are generated on the basis of the radio waves by the evaluation circuit 96.

The evaluation circuit 96 transmits its position data to a computer unit 102 through a bus line 100. The computer unit 102 is connected via an interface 104 to a receiving and transmitting unit 106, which is in turn connected to the radio antenna 78. The receiving and transmitting unit 106 receives and generates radio waves, which are received or emitted by the antenna 78. Data can be transmitted from the computer unit 88 to the computer unit 102 and vice versa by the receiving and transmitting units 90, 106 and the radio antennas 74, 78. The connection between the radio antennas 74, 78 can be direct, for example, in an authorized radio range such as CB radio or the like, or can be provided via one or more relay stations, for example, if the receiving and transmitting units 90, 106 and the radio antennas 74, 78 operate according to the GSM standard or another suitable standard for mobile telephones.

The computer unit 102 is connected to a steering unit 108, which controls the steering angle of the front, steerable wheels 64. In addition, the computer unit 102 transmits velocity signals to a velocity specification unit 110, which controls the velocity of the transport vehicle 12 via a variation of the engine speed of the transport vehicle 12 and/or the transmission ratio. In addition, the computer unit 102 is connected to a permanent memory 120.

The computer unit 88 is connected to a control unit 112 on board the harvesting machine 10. The control unit 112 is connected to a steering unit 114, which controls the steering angle of the rear, steerable wheels 24. In addition, the control unit 112 transmits velocity signals to a velocity specification unit 116, which controls the velocity of the transport vehicle 12 via a variation of the transmission ratio. The control unit 112 is furthermore connected to a throughput sensor 118, which detects the distance between the feed rollers in the intake channel, to a sensor for detecting the position of sensing bands 62 attached to a distributor tip of the harvesting header 28, a permanent memory 122, the processing circuit 130, and to the actuators 46, 48, and 50.

In harvesting operation, the harvesting machine 10 is steered along the harvested material edge in that the control unit 112 gives steering signals to the steering unit 114, which are based on the signals from the position determination unit 72 and a map stored in the memory 122, which define a path planned for the coming harvesting process, or on signals from the sensing bands 62 or a combination of both signals. Alternatively, or additionally, the harvested material edge is detected using a two-dimensional or three-dimensional camera and an image processing system or a laser or ultrasonic sensor or scanner and is used to generate the steering signal for the steering unit 114. The path of the harvesting machine 10 does not necessarily have to run absolutely straight, but can also comprise curves depending on the shape of the field. In addition, provision is made for turning processes at the end of the field.

The advance velocity of the harvesting machine 10 can be specified by its driver, or the control unit 112 uses the throughput signals of the throughput sensor 118 in order to activate the velocity specification unit 116 such that a desired throughput is achieved by the harvesting machine 10.

In addition, the transport vehicle 12 is guided parallel to the harvesting machine 10, in that the control unit 112 transmits data with respect to the position to be maintained by the transport vehicle 10 to the computer unit 102 via the computer unit 88 and the radio antennas 74, 78. The computer unit 102 then activates the steering unit 108 and the velocity specification unit 110 accordingly in that it compares the position detected using the position determination unit 76 to the position to be maintained and gives appropriate steering signals to the steering unit 108 depending on the result of the comparison. This comparison and the generation of the steering signal for the steering unit 108 could also be carried out by the computer unit 88 and/or the control unit 112 on board the harvesting machine 10, wherein the position data are transmitted from the position determination unit 76 of the transport vehicle via the radio antennas 74, 78 to the harvesting machine 10, while the steering signals are transmitted in the reverse direction back to the transport vehicle 12. The transport vehicle 12 also follows the harvesting machine 10 when traveling on curves and when turning at the end of the field. The discharge unit is oriented by appropriate activation of the actuators 46, 48, 52 by the control unit 112 automatically onto the cargo container 18, for which purpose the control unit 112 uses signals from the processing circuit 130 and/or from the computer unit 88.

For this purpose, the load status of the cargo container 18 is detected, for which purpose the signals of the processing circuit 130 are used, which can be supplemented or replaced by highly integrated signals of throughput sensor 118 and/or signals from a content sensor 124, designed as a near-infrared spectrometer, for detecting contents of the harvested material. As long as the cargo container 18 is not completely filled, it is checked whether a desired target fill level is reached at the point of the cargo container 18 to which harvested material is presently applied. If this is the case, the discharge unit is oriented on another point of the cargo container 18. A specific loading strategy is used here, which fills the cargo container 18 from front to back or vice versa, wherein in each case harvested material is applied to one point 134 until a specific fill level is reached, and then harvested material is loaded again at a point displaced by one step width to the front or rear. The harvested material can be applied here to the middle of the cargo container 18 with respect to the lateral direction, or another laterally offset point (cf. reference sign 134′ in FIG. 3, for which purpose the discharge direction 136, 136′ is changeable by means of the discharge flap 50 in that the discharge flap can be moved into the position 50′), or it can be applied to both in succession. The signals of the processing unit 130 are accordingly used in step 212 to activate the actuators 46, 48, 52. Additionally or alternatively, the position of the transport vehicle 12 is varied in relation to the harvesting machine 10 in the forward direction and/or in the lateral direction in that the control unit 112 transmits corresponding data with respect to the position to be maintained by the transport vehicle 10 to the computer unit 102 via the computer unit 88 and the radio antennas 74, 78. The path of the harvested material between the delivery end of the discharge unit and the cargo container 18 can thus be kept relatively short, which has the advantages that in the event of wind, few harvested material losses result and the harvested material is pre-compacted on the cargo container 18.

It is to be noted that in a simplified embodiment, the driver of the harvesting machine 10 steers it and specifies its velocity, while the drivers of the transport vehicles 12 steer them and specify their velocities. The control unit 112 then only controls the actuators 46, 48, and 52.

It is apparent on the basis of the preceding statements that the processing unit 130 is capable of identifying the outer border of the cargo container 18 on the basis of the image signal—containing distance information—of the electro-optical unit 126 and of identifying the three-dimensional location of the corners of the cargo container 18 with respect to the electro-optical unit. On the basis of the three-dimensional location of the corners of the cargo container 18, the actuators 46, 48, 52 and possibly 108 and 110 are activated in terms of loading the cargo container 18 in accordance with a predetermined loading strategy. The distance information is, if the electro-optical unit 126 is a stereo camera (in particular having horizontal or vertical baseline between the cameras), contained in the differences (disparities) of the images of the two cameras. If the electro-optical unit directly measures the distance, whether as a PMD camera or as a scanning distance meter, distance information is also contained in the image signal of the electro-optical unit 126.

Moreover, the processing unit 130 can identify the fill level of the cargo container 18 on the basis of the image signal of the electro-optical unit 126 in a manner known per se.

The functionality of the processing circuit 130 used as the system for image-based identification of the position of the cargo container 18 is shown in FIG. 5. The image signal of the electro-optical unit 126 is supplied to a system 138 which, on the one hand, generates a disparity image 140, and, on the other hand, carries out a semantic segmentation 142, the result of which is used to identify or estimate the two-dimensional position 144 of the corners of the cargo container 18. The three-dimensional coordinates 146 of the corners of the cargo container 18 are generated in spatial coordinates on the basis of the position 144 of the corners and the disparity image 140 (or spatial coordinates of the upper edges of the cargo container 18 derived therefrom).

The system 138 is a machine-learning system and is configured to learn solutions to multiple problems simultaneously. A learning process (training) is thus carried out on the basis of training images of different cargo containers 18 occurring in practice and associated information with respect to the location of the cargo container 18 within the image. The system 138 is then capable of outputting the disparity image 140 and the two-dimensional position 144 of the corners on the basis of real distance images of the electro-optical system 126. The system 138 can be a trainable system (model, neural network, or the like) embodied in any hardware and software, which has previously been trained on the basis of training images and associated information with respect to the location of the cargo container 18.

The system 138 is thus capable of so-called multitask learning, which is a subfield of machine learning in which multiple training problems are solved simultaneously. The system is thus trained to learn the multiple problems and associated solutions (here: generating the disparity image 140 and segmentation 142 as well as determining the position 144 of the corners) simultaneously and executing them later. This reduces the size of the system in relation to separate systems and the computing time, which permits it to be run in available hardware and in real time. In the present case, the system 138, as mentioned, is used to calculate the disparity image 140 and the two-dimensional position 144 of the corners.

Information about how far an object is from the electro-optical system 126 is contained in the disparity images 140. The distance of the cargo container 18 from the electro-optical system 126 can thus be identified here. Instead of, for example, a block matching algorithm known per se (cf. US 2019/0294914 A1 for the identification of balls) for the disparity estimation, which is a classic image processing algorithm having many restrictions and in many cases supplies an unusable disparity image, which results in poor identification of the cargo container 18, a trainable system 138 is therefore used here, which is trained on thousands of training images to generate the most accurate possible disparity images 140.

Furthermore, a semantic segmentation of the distance images of the electro-optical system 126 is trained simultaneously with the generation of the disparity images 140 by the system 138 and is carried out later. While previous systems did not use image information for the identification of the cargo container 18 (at most for the identification of its type, cf. the discussion in the background section), which simply neglects a part of the available information, for example, whether a detected object is a cargo container 18 or simply an object having rectangular shape, this disadvantage is avoided according to the present disclosure in that a semantic segmentation is carried out. For this purpose, all pixels in the images of the electro-optical unit 126 which belong to a common object category are marked and grouped. This procedure can be used to detect the accurate location of the cargo container 18 in the image field of the electro-optical unit 126 (in a two-dimensional coordinate system, which is related in particular to the image supplied by the electro-optical unit 126). For this purpose, the machine-learning system (simultaneously with the training process for the disparity image) is trained using thousands of training images and information on the object category to learn the problem and solution of the semantic segmentation.

If the image parts associated with the cargo container 18 are known on the basis of the semantic segmentation 142, the identification of the two-dimensional position 144 of the corners of the cargo container 18 is unproblematic and is possible with little computing effort.

Finally, the position 114 of the corners 144 identified in the image signal of the electro-optical unit 126 is used jointly with information derived from the three-dimensional disparity image 140 on the spatial location of the upper edges of the cargo container 18 to ascertain the spatial coordinates 146 of the corners of the cargo container 18 and transmit them to the control unit 112.

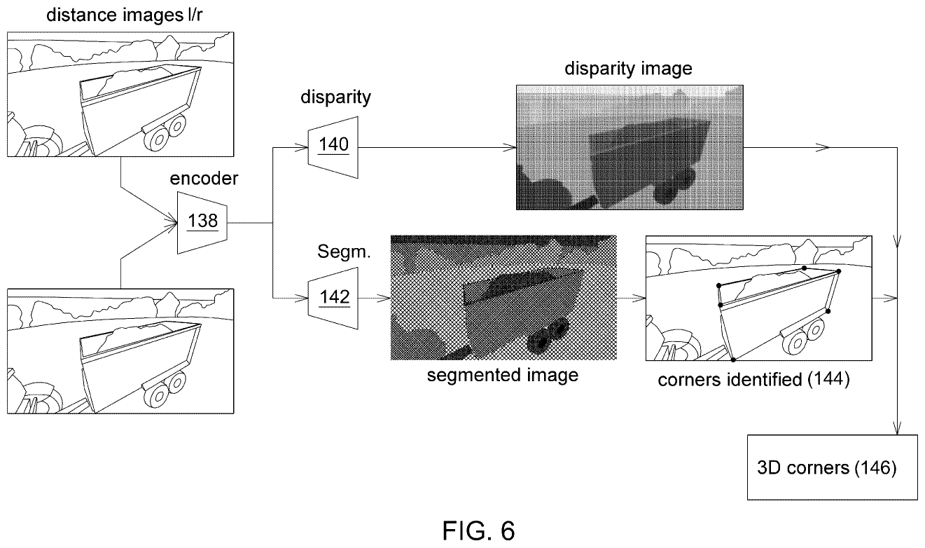

The described procedure is also shown in FIG. 6 on the basis of exemplary images.

The procedure described so far provides for carrying out the generation of the disparity image 140, on the one hand, and the segmentation 142 and identification of the corners, on the other hand, by way of a single machine-learning system 138, which moreover carries out both tasks simultaneously. Instead, two separate machine-learning systems 138 could also be used for generating the disparity image 140, on the one hand, and the segmentation 142. It would also be conceivable to carry out one or both of these tasks (generation of the disparity image 140, on the one hand, and the segmentation 142 and identification of the corners, on the other hand) by way of a classic system proceeding in an algorithmic manner and to dispense with a self-learning system and to carry out both tasks by way of systems proceeding in an algorithmic manner, or to carry out only one of the tasks by way of the self-learning system 138 and to achieve the other by way of the algorithmically operating system. With a step-by-step implementation, the best solution with respect to the implementation of possible algorithms on given hardware can thus be achieved.

Various features are set forth in the following claims.

What is claimed is:

1. A system for image-based identification of the position of a cargo container comprising edges and corners, the system comprising:
an electro-optical unit, which is or can be directed on the cargo container and is configured to provide an image signal which contains distance information, and
an electronic evaluation unit, which is connected in a signal-transmitting manner to the electro-optical unit and is configured to generate, on the basis of the image signal, a distance image with respect to the spatial location of the edges of the cargo container and a two-dimensional estimation of the position of the corners of the cargo container within the image and to provide a position signal with respect to the spatial position of the corners of the cargo container on the basis of the distance image and the estimation.

2. The system as claimed in claim 1, wherein the electronic evaluation unit comprises a system configured for generating the distance image and/or the estimation, which is trained on the basis of training images and associated information with respect to the location of the cargo container and is configured in particular to learn solutions to multiple problems simultaneously.

3. The system as claimed in claim 2, wherein the system is configured to carry out a semantic segmentation to identify the cargo container and to identify the corners of the cargo container in the part of the image identified as the cargo container.

4. The system as claimed in claim 1, wherein the electro-optical unit is a stereo camera and the distance image is a disparity image.

5. The system as claimed in claim 2, wherein the electro-optical unit is a stereo camera and the distance image is a disparity image.

6. The system as claimed in claim 3, wherein the electro-optical unit is a stereo camera and the distance image is a disparity image.

7. The system as claimed in claim 1, wherein the evaluation unit is configured to supply the position signal to a control unit, which is configured to use the position signal to generate a control signal for an actuator for the automatic supervision of a transfer process of material into the cargo container.

8. The system as claimed in claims 2, wherein the evaluation unit is configured to supply the position signal to a control unit, which is configured to use the position signal to generate a control signal for an actuator for the automatic supervision of a transfer process of material into the cargo container.

9. The system as claimed in claim 3, wherein the evaluation unit is configured to supply the position signal to a control unit, which is configured to use the position signal to generate a control signal for an actuator for the automatic supervision of a transfer process of material into the cargo container.

10. The system as claimed in claim 4, wherein the evaluation unit is configured to supply the position signal to a control unit, which is configured to use the position signal to generate a control signal for an actuator for the automatic supervision of a transfer process of material into the cargo container.

11. A vehicle, in particular a harvesting machine, having means for picking up and/or storing and for transferring material into the cargo container, comprising a system as claimed in claim 1.

12. A method for image-based identification of the position of a cargo container comprising edges and corners, the method having the following steps:
providing an image signal which contains distance information by way of an electro-optical unit that is or can be directed on the cargo container, and
generating a distance image with respect to the spatial location of the edges of the cargo container and a two-dimensional estimation of the position of the corners of the cargo container within the image by way of an electronic evaluation unit on the basis of the image signal and providing a position signal with respect to the spatial position of the corners of the cargo container on the basis of the distance image and estimation.

13. The method as claimed in claim 12, wherein the electronic evaluation unit comprises a system, which is configured for generating the distance image and/or the estimation and which is trained on the basis of training images and associated information with respect to the location of the cargo container and in particular learns multiple problems simultaneously.

14. The method as claimed in claim 13, wherein the system carries out a semantic segmentation to identify the cargo container and identifies the corners of the cargo container in the part of the image identified as the cargo container.

15. The method as claimed in claim 12, wherein the electro-optical unit is a stereo camera and the distance image is a disparity image.

16. The method as claimed in claim 13, wherein the electro-optical unit is a stereo camera and the distance image is a disparity image.

17. The method as claimed in claim 14, wherein the electro-optical unit is a stereo camera and the distance image is a disparity image.
